(19) United States
(12) Patent Application Publication
(10) Pub. No.: US 2003/0101416 A1
(43) Pub. Date: May 29, 2003

(54) Creating XML documents

(75) Inventors: Simon McInnes, London (GB); Luke O. Trigg, Harlow (GB); Tim P. Wood, Surbiton (GB); Alastair J. C. Qualtrough, London (GB)

Correspondence Address: PILLSBURY WINTHROP, LLP, P.O. BOX 10500, MCLEAN, VA, 22102, US

(73) Assignee: EVOLUTION CONSULTING GROUP PLC, London (GB)

(21) Appl. No.: 10/303,144

(22) Filed: Nov. 25, 2002

Related U.S. Application Data
(60) Provisional application No. 60/332,509, filed on Nov. 26, 2001.

(51) Int. Cl. G06F 15/00

(52) U.S. Cl. 715/513

(57) ABSTRACT

A template is created for use in a wordprocessing application to allow XML identifiers to be assigned to content of a wordprocessing document created using the template. The template is created by creating hidden variables in a template, each hidden variable having a name and a value. Each hidden variable is named with a naming string wherein each naming string comprises an XML identifier. In use of the template, information can be input using a wordprocessing application to provide a value to each said hidden variable, the value corresponding to the content associated with the XML identifier. The method and template are particularly useful in MS (Microsoft®) Word.

The present application claims priority to U.S. Provisional Application No. 60/332,509, filed Nov. 26, 2001, the entirety of which is hereby incorporated into the present application by reference.

The present invention relates generally to the creation of XML documents using a word processing application such as MS (Microsoft®) Word.

XML is an internationally defined standard for the structure of document information which enables that information to be easily distributed. XML files consist of a hierarchical structure of identifiers, each identifier being associated with content. Thus during file creation it is necessary to associate together the content with its identifier. The association is defined in the XML file by pairings of so-called “tags”, wherein each tag contains the XML identifier and information showing whether the tag is a start tag or a finish tag. Information between the start and finish tags is proper to the XML identifier expressed in the tag.

The conventional representations of the start and finish tags for the exemplary XML identifier “DataInfo” are <DataInfo> and </DataInfo> respectively. The expressions <DataInfo> and </DataInfo> are termed herein XML tag pairings of the XML identifier “DataInfo”.

An explanatory example of an XML segment from an XML document or file is shown in Table 1.

TABLE 1

<Book>

<Author>

<First Name>

William

</First Name>
<Surname>

Shakespeare

</Surname>

</Author>
<Publisher>

English Books Ltd.

</Publisher>

</Book>

Table 1 shows that an item being considered is of the type “Book”, that it has an author and a publisher. The name of the publisher is specified by enclosure between <Publisher> and </Publisher> tags, and is termed herein the content of the XML identifier “Publisher”.

The XML identifier “Author” has two child identifiers associated with it, namely “First Name” and “Surname”. These child relationships are shown by indenting children from parents in a tree structure, and thus it will be inferred that “Author” and “Publisher” are children of “Book”.

It is also desirable to represent this hierarchical position of an XML identifier with other XML identifiers.

Given the widespread use of MS Word in both private and business environments, there is a growing need or desire for the ability to use MS Word in the creation of XML (extensible Mark-up Language) files.

MS Word provides a number of features. These include:

Template—a stencil defining the initial layout of a document within MS Word. Templates may contain for example preset information, preset formatting styles, Form Fields and macros.

Continuous Section Break—a portion of a document in MS Word having its own page format information. The insertion of a continuous section break does not start a new page in the document into which it is inserted. Individual sections may be protected to prevent accidental deletion.

Form Field—a visible field within an MS Word document into which users can enter text, often in response to a prompt.

AddIn Field—a type of field supported by the MS Word object model into which generated information can be placed. These fields are not normally available via the standard MS Word user interface but must be created via a program.

Document Variable—a non-visible variable within an MS Word document which can be given a user-defined name and a user-allotted value.

Shape—an image that has been inserted into an MS Word document.

Bookmark—a non-visible place-marker within an MS Word document which can be given a user-defined name.

Similar or corresponding features to those described above may be found in other word processing applications or authoring tools, though different nomenclature may be used. For convenience, however, the terminology used above will be used throughout this specification.

According to a first aspect of the present invention there is a method of creating a template for use in a wordprocessing application to allow XML identifiers to be assigned to content of a wordprocessing document created using the template, the method comprising: creating hidden variables in a template, each hidden variable having a name and a value; and, naming each hidden variable with a naming string wherein each naming string comprises an XML identifier; whereby in use of the template information can be input using a wordprocessing application to provide a value to each said hidden variable, the value corresponding to the content associated with the XML identifier.

The use of hidden variables named by a string including the XML identifier allows the names to be readily parsed to identify the XML identifier. The link between the variable name and its value allows the ready retrieval of content. The fact that the variable is hidden means that the method can be implemented in a way such that a user only sees a wordprocessing document being created and is not confused or distracted by visible additional data.

The template is preferably an MS Word template and the MS Word hidden variables are MS Word Document Variables.

Information can be captured by copying information being input to the screen to the value field of the said variable.

By copying information being input, for instance via a keyboard, to the screen, a user is presented with the usual features and environment of MS Word document authoring. The integrity of the information being stored as content is assured.

Preferably the method comprises creating a pair of protected sections in said template with an unprotected section therebetween such that information can only be input to the unprotected section between the protected sections.

Such an unprotected section can be used to allow a user to input free text.

Preferably the template is an MS Word template and creating a pair of protected sections in said template with an unprotected section therebetween comprises: inserting a continuous section break, a first marker AddIn field, a first MS Word AddIn field to indicate the start of the unprotected section, a second continuous section break, a third continuous section break, a second marker AddIn field, a second MS Word AddIn field to indicate the end of the unprotected section, and a fourth continuous section break, the unprotected section thereby being located between the second and third continuous section breaks; and, naming each of said non-marker AddIn fields with a said naming string.

This allows for simple free text insertion during authoring of a document. A prompt may be displayed to the user to enter free text into the (unprotected) section.

By allotting a naming string to the AddIn fields that includes the relevant XML identifier data, integrity is assured.

It will be appreciated that AddIn Fields can be used for two purposes in the preferred embodiment, one to act as a “marker” for protected sections and one to indicate the start and end of different section types.

The method preferably comprises making the protected and unprotected sections invisible to a user.

The template is preferably an MS Word template and the method preferably comprises: inserting a continuous section break, a first MS Word AddIn field to indicate the start of a section, and a second MS Word AddIn field to indicate the end of said section; and, creating an MS Word Form Field; such that information that is input into the Form Field of an MS Word document created using the template can be copied to the Text field of said Form Field.

The method may comprise naming the HelpText field of the Form Field with a said naming string. Again, the use of a naming string including the XML identifier eases the task of obtaining XML information from the MS Word document.

The template is preferably an MS Word template and the method preferably comprises creating a Shape Variable or bookmark.

Preferably, at least one naming string has plural fields, one of said fields being a field for said XML identifier. Said naming string may have an index field for identifying said XML identifier. The method may then comprise writing to said index field information that uniquely identifies said XML identifier in the population of XML identifiers assigned by the method. The provision of a unique identifier allows ready referencing between XML identifiers without the need for string comparison.

The method may comprise incrementing a count value each time a said hidden variable is created, the writing comprising writing said count value to the index field. In this way, the index value corresponds to the order of creation of the XML identifiers. This technique is very simple to effect.

In a preferred embodiment, said naming string has a child identifier field for indicating the content of the index field of a parent XML identifier of the XML identifier, and the method comprises writing said content to the child identifier field. Other techniques are of course possible, such as for example use of a separate table of parent-child relations. However, incorporating this data in the naming string allows all the necessary data to be accessed in a simple and rapid fashion when the XML file is to be created from the MS Word information.

It is advantageous to provide a set of indicators each representative of a type of content for association with XML identifiers. In that case, the method may comprise allocating to a type field of said naming string one indicator showing the type of content associated with said XML identifier.

The set of identifiers may further comprise a further indicator that said XML identifier is a document type identifier. In that case, the method may comprise writing said further indicator to said type field in response to a determination that said XML identifier is a document type identifier. The document type is a fundamental feature of XML documents. Providing a field that is used to indicate a content type and using that field with a special identifier to indicate the document type XML identifier is an efficient use of the naming string.

Preferably the method comprises setting the value of a Document Variable, having said further indicator in said type field, to a predetermined string. By choice of a suitable predetermined string, for instance a suitable single character, cross-checks of data can be easily carried out.

Advantageously in the method, the set of indicators includes a first subset of identifiers for indicating that the value to the associated hidden variable is input during document creation. By choosing a first subset, a second subset may be selected to indicate that no further value is input during document creation.

According to a second aspect of the present invention, there is provided a template for use with MS Word, the template in use allocating names to hidden variables of an MS Word document, each name comprising an XML identifier, the template being arranged to allow creation of fields for display in a MS Word document using said template, said fields allowing input of content corresponding to the XML identifier, and to allow the content to be stored as a value of the corresponding hidden variable.

The hidden variables may be MS Word Document Variables.

Creation and use of an MS Word template can separate the control function of setting the rules from the authoring function in which the rules that have been set are implemented. This may afford a higher degree of enforceability of the rules than is possible in prior systems for providing XML files.

The method may be implemented by code of a computer-readable medium.

According to a third aspect of the present invention, there is provided a method of authoring an XML document using a wordprocessing application having a template created as described above or a template as described above, the method comprising: using said template during creation of a wordprocessing document to allow information that is input to be captured, thereby to provide a value to each said hidden variable.

According to a fourth aspect of the present invention, there is provided a method of forming an XML-enabled document using MS Word, the XML-enabled document comprising a plurality of XML identifiers in hierarchical relationship with one another and content information predicated upon the XML identifier, the method comprising: defining a plurality of MS Word hidden variables; naming each hidden variable with a respective naming string, each string comprising data representative of a respective one of said XML identifiers and data representative of the hierarchical position of the respective XML identifier; using MS Word to input data; and, assigning as a value to each said hidden variable a data portion which is predicated on the said XML identifier.

According to a fifth aspect of the present invention, there is provided a method of forming an XML file from an XML-enabled document, the XML-enabled document including a plurality of XML identifiers and content associated with each XML identifier and being an MS Word document having a plurality of Document Variables, wherein each Document Variable has a name and a value, the name comprising a respective naming string, each naming string including information indicative of one of said XML identifiers, a position indicator indicative of the position of the said XML identifier in the order of occurrence of the said XML identifier of said XML-enabled document and a child identifier indicative of a parent XML identifier to said XML identifier, the method comprising: (a) selecting a Document Variable on the basis of its position indicator; (b) deriving the XML identifier from the selected Document Variable; (c) creating an XML tag pairing of the said XML identifier and outputting the start tag of said pairing; (d) retrieving and outputting the value of the selected Document Variable or associated Free-text area or Table or Image; and, (e) outputting the finish tag of said pairing.

Advantageously, the method further comprises: f) selecting a Document Variable having a child identifier indicative of the currently selected Document Variable; and performing steps (a) to (e) for said Document Variable.

Embodiments of the present invention will now be described by way of example with reference to the accompanying drawings, in which:

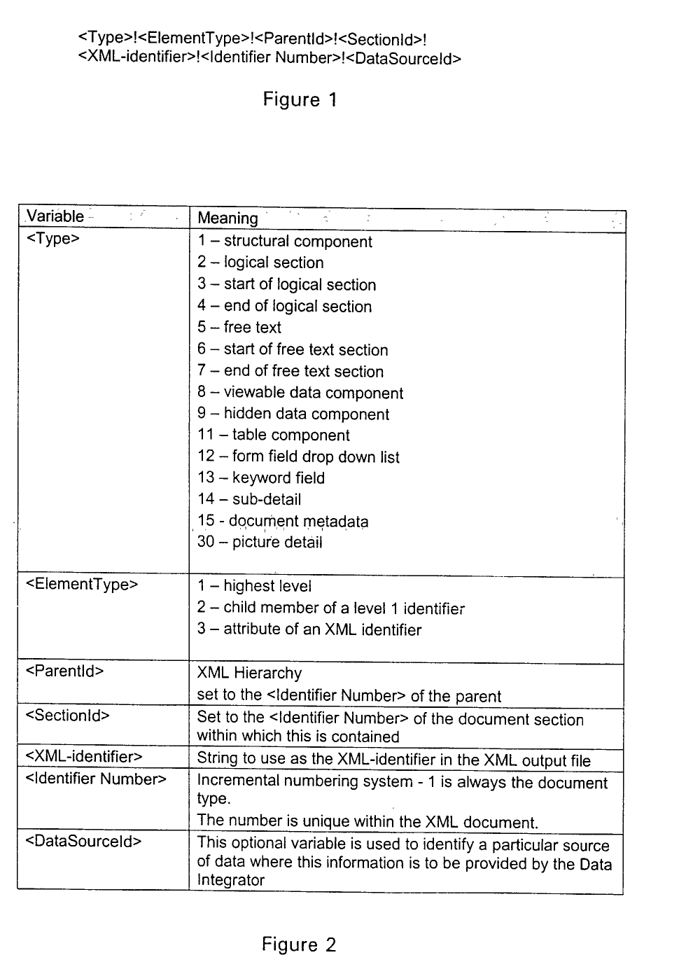

FIG. 1 shows an exemplary naming string;

FIG. 2 shows a table of the contents of the fields of the string of FIG. 1;

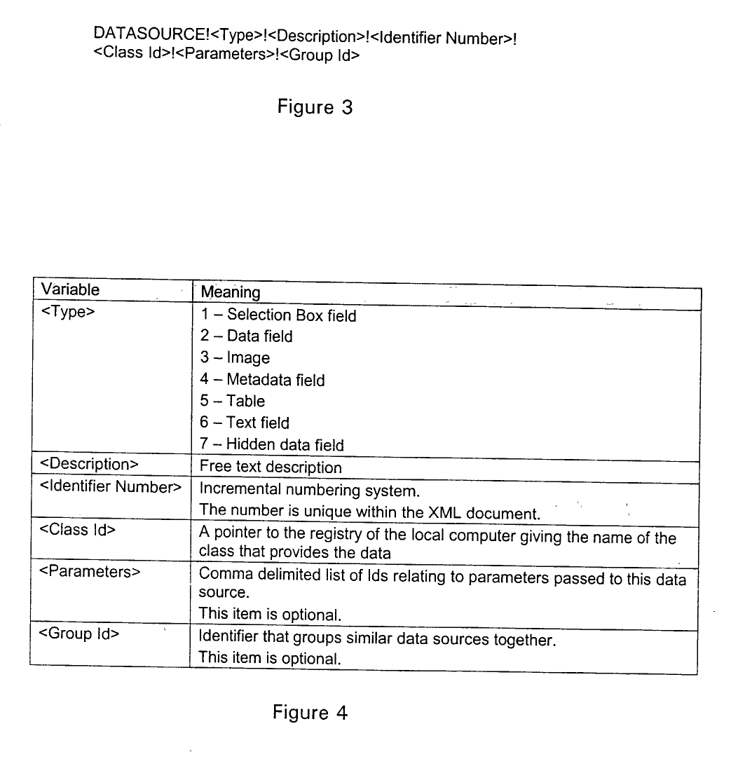

FIG. 3 shows an exemplary naming string useable in a datasource component;

FIG. 4 is a table showing the contents of the fields of the string of FIG. 3;

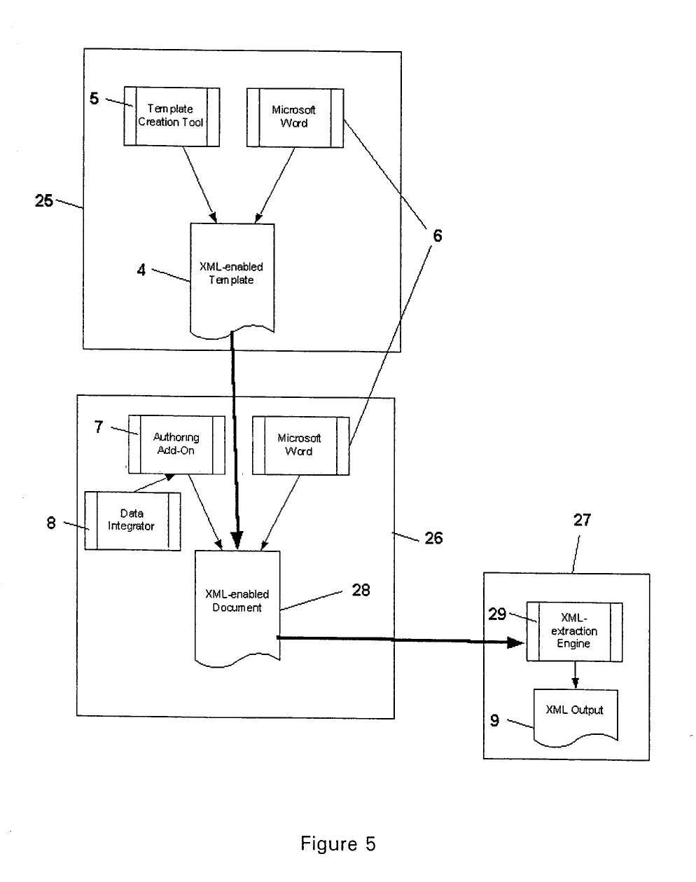

FIG. 5 shows a block diagram of an embodiment of an XML file creation system;

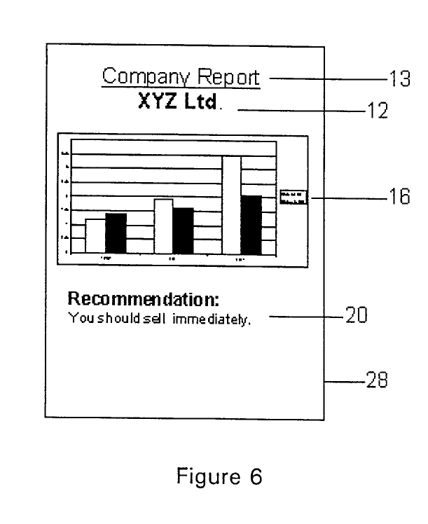

FIG. 6 shows a view of an outline of an MS Word document as it would appear on screen after authoring;

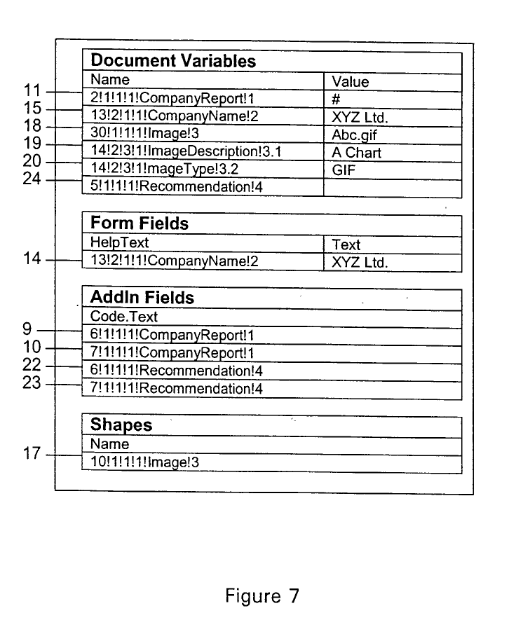

FIG. 7 shows MS Word hidden properties created using an embodiment of the invention in the creation of the document of FIG. 6;

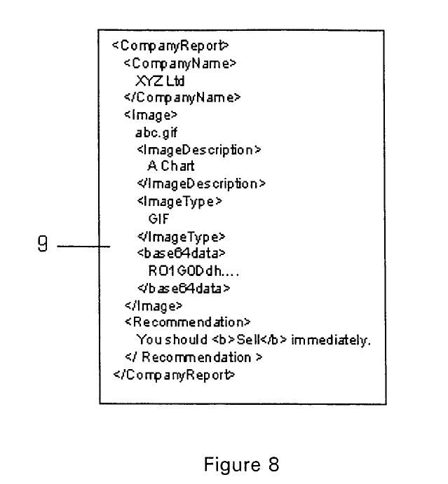

FIG. 8 shows an XML document derived from the document of FIG. 6; and,

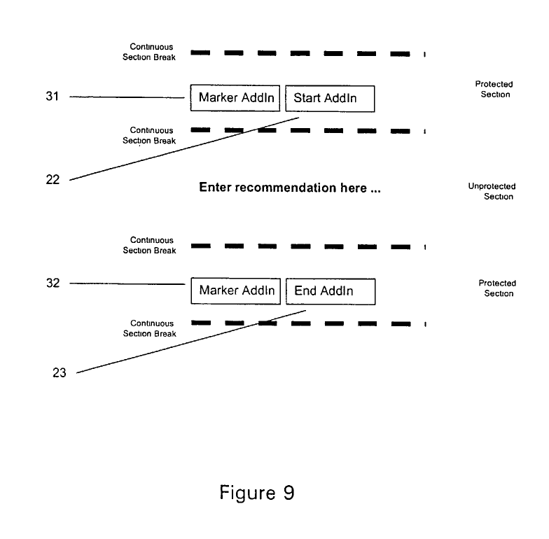

FIG. 9 is a representation of the mechanism of AddIn fields and continuous section breaks that are used to indicate a free-text area.

Referring first to FIG. 1, a naming string is shown which is used in the described embodiment. The naming string in this embodiment is multipurpose in that it may be used to form names of document variables or Shapes or Bookmarks, to form the HelpText of an MS Word Form Field and to form the Code.Text of an AddIn field. It is however possible to form different types of naming string for each purpose.

Referring to FIG. 1, the naming string comprises seven data fields separated by field delimiters, in this case exclamation marks. Exclamation marks are used in this embodiment because the standard for XML identifiers does not currently include exclamation marks. Hence there is no risk of confusion in determining whether the exclamation mark is part of an XML identifier or is instead a delimiter. Other delimiters could be used if appropriate. In the present embodiment, and referring to FIG. 2, the fields have the following meaning.

The first field is a “Type” field which, as indicated, discriminates between the kinds of information referred to by the XML identifier which forms part of the naming string. The Type field may be used to provide control information to determine how associated data is to be represented. Thus, for instance, a Type field indicating that the associated data is image content may be used to prevent the data being treated as text.

This Type field is also used to indicate that the present naming string refers to a document type XML identifier.

The second field is an “ElementType” field which distinguishes between elements of the highest hierarchical position, child members of such highest level elements, and elements that are attributes of an XML identifier.

Considering momentarily the sixth field, the “Identifier Number” field represents a numbering system unique within the XML document of concern. In this embodiment, this is derived from an incremental numbering system in which 1 is the document type because the document type identifier is conventionally the first created. Child members representing sub-detail (and thus carrying Type=14, see FIG. 2) will have an Identifier Number in the format “m.n” where m is the Identifier Number of the parent and n is the individual child Identifier Number (incrementing from 1) appropriate to the child of concern.

The third field is the “ParentID” field and is set to the value “Identifier Number” of the parent if the naming string is of a child XML identifier.

The fourth field is the “SectionID” field which is set to value “Identifier Number” for the document section within which the item of concern is contained.

The fifth field is the “XML Identifier” field and this is a string chosen to form the XML identifier in an XML output file.

The seventh field is the “Data Source Id” field. This is an optional variable that may be used to identify a particular source of data where this information is to be provided by a data integrator (see below).

The variables and meanings may be changed and/or extended beyond those given by way of example in FIG. 2.

Referring now to FIG. 3, an example of a naming string is shown which is used in this embodiment to form names of document variables that are used to point to data sources accessed during authoring. This naming string comprises seven data fields separated by field delimiters, in this case exclamation marks for the reasons discussed above. Other delimiters could be used if appropriate. In the present embodiment, and referring to FIG. 4, the fields have the following meaning.

The first field is preset to the string “DATASOURCE” and allows an easy way to recognise that the following information relates to an external datasource.

The second field is a “Type” field which indicates the nature of the external data source. Different data sources require varying levels of information to allow the required data item to be uniquely identified. A simple external datasource requires simply a pointer to a file on a computer drive; an XML data source may require the name of the tags at the start of the section that houses the data to be retrieved. If needed, this additional information is specified in child document variables.

The third field is a descriptive name given to the data source.

The fourth field is the “Identifier Number” field as previously described.

The fifth field is the “Class ID” which points to the external program dll that will supply the required information.

The sixth field is the “Parameters” field which allows for the incoming information to be specified.

The seventh field is the “Group Id” field which allows for similar data sources to be grouped together.

Again, the variables and meanings may be changed and/or extended beyond those given by way of example in FIG. 4.

Referring now to the schematic block diagram of FIG. 5, there is shown a template-creation block 25, an authoring block 26 and an analysis block 27. The template-creation block 25 relates to the creation of an XML-enabled template 4 which is used as a component in the creation of an XML-enabled MS Word document 28 in the authoring block 26. The XML information is extracted from the XML-enabled MS Word document for output as required by the analysis block 27.

In the template creation block 25 there is shown a template creation tool 5 which is typically supplied on a computer-readable medium such as a disk and which provides its own hierarchical structure for the creation of the XML-enabled template 4, in concert with MS Word 6. The template creation tool 5 in concert with MS Word 6 provides constraints and rules that ensure that the XML-enabled template 4 when created provides complete and valid information. It contains an algorithm for completion of the fields of the naming string such that the required relationships are achieved. In some cases, the relevant information is created automatically. For example, where a continuous section break is created, this involves the creation of fields indicative of the start and the end of the section and the type information is automatically added to the relevant naming strings without user intervention. Similarly, where the creation of one item of information requires the creation of a related item sharing data with it, the shared data is automatically copied across to avoid user error. The template creation tool 5 further creates sequential identifier indices to ensure that the hierarchy of XML identifiers is obtainable.

The template creation tool 5 itself implements the necessary rules for XML document creation. The resultant XML-enabled template 4 regulates the user by virtue of these in-built rules to ensure that the document created using the template is not an invalid document.

Turning now to the authoring block 26, an XML authoring add-on 7 is connected to a data integrator 8 such that the XML authoring add-on 7 can fetch data through the data integrator 8 for storage within an XML-enabled document 28. As will be discussed in more detail below, an author may in use of the authoring block 26 open the XML-enabled template 4 in MS Word 6 and with possible use of the authoring add-on 7 create an XML-enabled document 28.

After creation of the XML-enabled document 28, there is a final analysis stage in the analysis block 27. The analysis block 27 has an XML extraction engine 29 which converts information from the XML-enabled document 28 into an XML output file 9.

Referring now to FIGS. 6 to 8, an embodiment of the present invention will now be described in use in a specific example. It will be appreciated that the following description is merely exemplary and is non-limiting.

Referring first to FIG. 6, an exemplary document to be created with the aid of an MS Word template is a company report. The document has a standard form. In other words, it contains predictable types of content which are usually input in a specific order. In the present case, the content has an identifier 13 forming the title “company report” which will be common to all documents of this type. This title information is contained within the template.

Next there is information 12 which is input during the use of the template by a document author. Here, the information is the name of the company.

Thirdly there is a chart 16, called by the document author during use of the template from another source, such as for example MS Excel or any other image-creating program.

The fourth item of content (the word “Recommendation”) is provided by use of the template itself.

After “Recommendation” is the fifth item of content, a free-text area 20 to be used by the document author. In this case, this is to store text relating to advice given for this company.

A first task, given knowledge of the content of the document for which a template is to be created, is to analyse the document into its component parts. This is done bearing in mind the required output of an XML file and requires the creation of XML identifiers as appropriate to the type of document of concern. To identify the present type of document, an XML identifier is selected as “CompanyReport”. In the present example, where the document is a company report, other XML identifiers include:

an XML identifier “CompanyName” indicating the name of the company and having as associated content the name of the company,

an XML identifier “Image” indicating the presence of an image and having as associated content the file name of that image,

an XML identifier “ImageDescription”, which is a child of “Image”, indicating a description of the image and having as content an image descriptor,

a second XML identifier “ImageType” which is a child of “Image” and is at the same child level as “ImageDescription” having content indicating the type of image, and

an XML identifier “Recommendation” indicating the recommendation and having as content a free text section which forms the recommendation.

Generally speaking, there are three main stages in the production of the XML representation of the company report shown in FIG. 6. Similar stages will be used in creation of other documents. These stages will be described based upon the diagram of FIG. 5 and are:

1. creation of an XML template;

2. using the XML template during the course of creation of a Word document; and,

3. analysing the result of the creation of the Word document to then extract an XML output file.

1. Creation of Template

The process for creating the XML template includes using input information and inserting it appropriately into the naming string defined as shown in FIG. 1 thereby to create hidden variables named by the string and having associated parameters which may be assigned. The information may be input from the keyboard or from pull-down menus or from a toolbox of preset options to insert the relevant information into the naming string.

As noted above, a fundamental requirement of valid XML documents is the document type declaration. Thus, and referring to FIGS. 7 and 8, the first operation in creating the template is to define the type of document addressed by the template, in this case “company report”. The template creation program creates a “continuous section break” in the template and inserts a Microsoft AddIn Field 9 at the start of the section, sets the protection on the section to prevent deletion, and then inserts a second AddIn Field 10 indicating the end of the section. The template creation tool 5 then minimises the section so that the AddIn Fields become invisible. As known, each AddIn Field has a property called “Code.Text”. At present, this property is unassigned.

The tool 5 then creates an MS Word Document Variable 11 and assigns to this Document Variable 11 a Name, in the form of a naming string as described with reference to FIGS. 1 and 2. The string used as the Name of the Document Variable 11 in this example is shown in FIG. 7.

Document Variables include a Name and a Value. In the present case, no Value will be used and hence the template creation tool 5 assigns “#” as the value. Using the information provided to define the Name of the Document Variable 11, the Code.Text properties of the AddIn fields 9 and 10 are now formed. From FIG. 7 it will be seen that the template creation tool 5 indicates the section start AddIn Field 9 as type 6, and the section end AddIn Field 10 as type 7, and then appends Fields 2 to 5 from the document type naming string. It then appends the value “1” to indicate “ownership” by the document type.

To enable the user of the template to input the name of the company of concern, the template creation tool 5 creates a “FormField” 14 having a HelpText property comprising a naming string of the type shown in FIG. 1. The Text property (i.e. the information that will be displayed by the template on the screen of the user) is set to the string “enter name of company”. The template creation tool 5 creates a second Document Variable 15 having Name corresponding to HelpText of the form field and with a Value corresponding to Text from the form field. When the information is typed into the form field by the template user, it will be understood that the string “enter name of company” will be replaced by the name of the company.

Having completed this part of the template, the template designer is presented by the template creation tool 5 with a number of options, for example “define keyword field”, “define free text area”, “define chart”, “define table”, and, being aware that the next requirement is to define the chart area 16, will select the corresponding option. Upon such selection, the template creation tool 5 allows the insertion of image information into the document using a suitable picture file. To do this, there is created a Shape Variable 17 which is named using the data structure shown in FIGS. 1 and 2. A Document Variable 18 is created having a Name set according to the name string of FIG. 1 and having a value which is set by the designer to the name of the initial picture file.

To fully identify the chart area 16, two child Document Variables 19, 20 are created. These Document Variables 19, 20 are named using a name string as shown in FIG. 1 and respectively hold as their values a description of the picture and the type of image. It will be noted from FIG. 7 that the Identifier Number for the two child Document Variables show the hierarchical relationship to the Document Variable 18 as the child Document Variables represent sub-detail of the Document Variable 18.

In this example, it is assumed that the user may want to refresh the chart 16 with the latest version at authoring time. A document variable 30 is constructed that points to the location of this chart. This document variable is named using a naming string as shown in FIG. 3 and holds as its value the physical location of the image. The Identifier Number is then appended to the Document Variable 18 so that this association is linked.

Finally, the template designer is again presented with a number of options by the template creation tool 5 and selects “enter free text”. With reference to FIG. 9, the template creation tool 5 thereupon creates a first continuous section break, a marker AddIn field 31 to allow for identification of the protected section, a Microsoft Word AddIn Field 22 to indicate the start of the section, a second continuous section break, a third continuous section break, a marker AddIn field 32 to allow for identification of the protected section, a Microsoft Word AddIn Field 23 to indicate the end of the free-text section, and a fourth continuous section break. These sections are minimised to effectively make them invisible. A Document Variable 24 is created and is named using a naming string (“5!1!1!1!Recommendation!5”). The template designer will then typically enter a prompt into the free text section such as “enter recommendation here”. The Code.Text of each AddIn Field 22, 23 is then set by the template creation tool 5 in compliance with the naming string of FIG. 1.

The final step of the process is to loop through all of the marker AddIn fields and set protection on the sections within which they are located in order to prevent accidental deletion of these sections. This is done as a final step so that the template designer can still freely work on the template up to this point.

This completes stage 1, creation of the XML template 4. It will be understood that the XML-enabled template 4 may be created and implemented on the same machine, or may itself be provided as a machine-readable product loaded on to a computer or computer network.

2. Using the XML Template

In the use or authoring phase, the XML-enabled template 4 is opened in MS Word so that the result of using MS Word is an XML-enabled document. The template 4 will be presented on the screen as a form document with prompts to enter information, e.g. “enter name of company” and “enter recommendation”. The user keys a company name into the company name field 12 and the authoring add-on 7 automatically copies the text entered into the associated Document Variable 15. In this example, it also makes a call to the data integrator 8 to retrieve the associated company chart 16. It knows the whereabouts of this chart by referring to the datasource description in document variable 30. The company chart 16 replaces the chart currently in the XML-enabled document 28 and the information in the associated Document Variables 18, 19, 20 is updated. Finally, in this phase the author enters free-text (e.g. recommendation) information into the document.

3. Analysing the Results

Once an XML-enabled document 28 is created, the extraction engine 29 firstly parses the Document Variables in the order of their identifier number and uses the XML-identifier field from the name string to produce the required XML string pairings. For each document variable, the string pairs take the form <XMLIdent> and </XMLIdent> where “XMLIdent” is the content of the XML-identifier field of the name string. The first string pair is output and then any remaining Document Variables having a parent corresponding to the current Document Variable are parsed. Then the second of the XML string pairs is output.

Each time a Document Variable that is a child is found, the XML string pairings are formed as above: the first is output, then the Document Variable value and then the second. Should a child also have children, then the children are processed before the second of the string pairings is output. As each new level is entered, a new level of indentation is output. Output goes to a new line each time.

With some MS Word features, such as tables and images or free text, special additional actions may be needed to produce the full XML representation. In the case of an image, this is typically to output a binary representation of the image. In the case of a table, this is to output row and column separators. In the case of free text, this is to output the text that was input into this section on the Word Document.

The resultant XML output, shown in FIG. 8, may then be forwarded to other users as required.

It will be understood that the XML extraction engine 29 may be invoked immediately from the authoring add-on 7 or may be run at a later time. It may be run on a different machine that has access to the XML-enabled document 28.

The following general features have been described in detail above:

use of the hidden property HelpText Field with the Form Field function of MS Word to allow the user to put input data into text boxes within protected sections;

the use of Document Variables to store information pertaining to images;

the use of the name of Document Variables to store information including the XML tag with the Value property storing the Value of the element;

the use of the continuous section break together with AddIn Fields for the start tag, an AddIn Field for the protection tag and a second continuous section break minimised to be invisible with yet another AddIn Field as the end tag for MS Word free-text areas so as to delimit free-text areas while preventing the user from deleting or moving into protected sections of the document;

use of Document Variable Fields to determine whether an Identifier is visible or invisible; and,

use of the name field of shapes to store information pertaining to charts and pictures and to store the anchor property of frames to protect free-floating text.

It will be appreciated that HelpText, Document Variable content, name fields, anchors and continuous section breaks together with AddIn Fields either are inherently invisible or may be made invisible. This allows for a clean screen presentation and allows for intuitive authoring by users.

Embodiments of the present invention have been described with particular reference to the examples illustrated. However, it will be appreciated that variations and modifications may be made to the examples described within the scope of the present invention.

1. A method of creating a template for use in a wordprocessing application to allow XML identifiers to be assigned to content of a wordprocessing document created using the template, the method comprising:
creating hidden variables in a template, each hidden variable having a name and a value; and,
naming each hidden variable with a naming string wherein each naming string comprises an XML identifier;
whereby in use of the template information can be input using a wordprocessing application to provide a value to each said hidden variable, the value corresponding to the content associated with the XML identifier.

2. A method according to claim 1, wherein the template is an MS Word template and the hidden variables are MS Word Document Variables.

3. A method according to claim 2, comprising creating a pair of protected sections in said template with an unprotected section therebetween such that information can only be input to the unprotected section between the protected sections.

4. A method according to claim 3, wherein the template is an MS Word template and wherein creating a pair of protected sections in said template with an unprotected section therebetween comprises:
inserting a continuous section break, a first marker AddIn field, a first MS Word AddIn field to indicate the start of the unprotected section, a second continuous section break, a third continuous section break, a second marker AddIn field, a second MS Word AddIn field to indicate the end of the unprotected section, and a fourth continuous section break, the unprotected section thereby being located between the second and third continuous section breaks; and,
naming each of said non-marker AddIn fields with a said naming string.

5. A method according to claim 3, comprising making the protected and unprotected sections invisible to a user.

6. A method according to claim 1, wherein the template is an MS Word template and comprising:
inserting a continuous section break, a first MS Word AddIn field to indicate the start of a section, and a second MS Word AddIn field to indicate the end of said section; and,
creating an MS Word Form Field;
such that information that is input into the Form Field of an MS Word document created using the template can be copied to the Text field of said Form Field.

7. A method according to claim 6, comprising naming the HelpText property of the Form Field with a said naming string.

8. A method according to claim 1, wherein the template is an MS Word template and comprising creating a Shape Variable or Bookmark.

9. A method according to claim 1, wherein at least one naming string has plural fields, one of said fields being a field for said XML identifier.

10. A method according to claim 9, wherein said naming string has an index field for identifying said XML identifier, the method comprising writing to said index field information that uniquely identifies said XML identifier in the population of XML identifiers assigned by the method.

11. A method according to claim 10, comprising incrementing a count value each time a said hidden variable is created, and wherein said writing comprises writing said count value to the index field.

12. A method according to claim 9, wherein said naming string has a child identifier field for indicating the content of the index field of a parent XML identifier of the XML identifier, the method comprising writing said content to the child identifier field.

13. A method according to claim 9, comprising providing a set of indicators each representative of a type of content for association with XML identifiers, the method comprising allocating to a type field of said naming string one indicator from the set showing the type of content associated with said XML identifier.

14. A method according to claim 13, wherein said set of indicators comprises a further indicator that said XML identifier is a document type identifier, the method comprising writing said further indicator to said type field in response to a determination that said XML identifier is a document type identifier.

15. A method according to claim 14, comprising setting the value of a Document Variable, having said further indicator in said type field, to a predetermined string.

16. A method according to claim 13, wherein said set of indicators includes a first subset of identifiers for indicating that the value to the associated hidden variable is input during document creation.

17. A computer-readable medium containing code for causing a computer to perform the method of claim 1.

18. A computer program for causing a computer to perform the method of claim 1.

19. A template for use with MS Word, the template in use allocating names to hidden variables of an MS Word document, each name comprising an XML identifier, the template being arranged to allow creation of fields for display in a MS Word document using said template, said fields allowing input of content corresponding to the XML identifier, and to allow the content to be stored as a value of the corresponding hidden variable.

20. A template according to claim 19, wherein the hidden variables are MS Word Document Variables.

21. A method of authoring an XML document using a wordprocessing application having a template created according to claim 1, the method comprising:
using said template during creation of a wordprocessing document to allow information that is input to be captured, thereby to provide a value to each said hidden variable.

22. A method of authoring an XML document using a wordprocessing application having a template according to claim 19, the method comprising:
using said template during creation of a wordprocessing document to allow information that is input to be captured, thereby to provide a value to each said hidden variable.

23. A method of forming an XML-enabled document using MS Word, the XML-enabled document comprising a plurality of XML identifiers in hierarchical relationship with one another and content information predicated upon the XML identifier, the method comprising:
defining a plurality of MS Word hidden variables;
naming each hidden variable with a respective naming string, each string comprising data representative of a respective one of said XML identifiers and data representative of the hierarchical position of the respective XML identifier;
using MS Word to input data; and,
assigning as a value to each said hidden variable a data portion which is predicated on the said XML identifier.

24. A method of forming an XML file from an XML-enabled document, the XML-enabled document including a plurality of XML identifiers and content associated with each XML identifier and being an MS Word document having a plurality of Document Variables, wherein each Document Variable has a name and a value, the name comprising a respective naming string, each naming string including information indicative of one of said XML identifiers, a position indicator indicative of the position of the said XML identifier in the order of occurrence of the said XML identifier of said XML-enabled document and a child identifier indicative of a parent XML identifier to said XML identifier, the method comprising:
(a) selecting a Document Variable on the basis of its position indicator;
(b) deriving the XML identifier from the selected Document Variable;
(c) creating an XML tag pairing of the said XML identifier and outputting the start tag of said pairing;
(d) retrieving and outputting the value of the selected Document Variable or associated Free-text area or Table or Image; and,
(e) outputting the finish tag of said pairing.

25. A method according to claim 24, comprising:
(f) selecting a Document Variable having a child identifier indicative of the currently selected Document Variable, and performing steps (a) to (e) for said Document Variable having a child identifier indicative of the currently selected Document Variable.
